(19) United States
(12) Patent Application Publication
(10) Pub. No.: US 2012/0091335 A1
(43) Pub. Date: Apr. 19, 2012

(54) SURFACE SAMPLING SYSTEMS FOR COLLECTING VOLATILIZED SAMPLES

(75) Inventor: Cyril V. Thompson, Knoxville, TN (US)

(73) Assignee: UT - Battelle, LLC.

(21) Appl. No.: 12/906,946

(22) Filed: Oct. 18, 2010

(51) Int. Cl. H01J 49/00; G01N 1/10

(52) U.S. Cl. 250/288; 73/863.11

(57) ABSTRACT

The sampling system includes a transfer tube and a sampling head configured to volatilize a sample from a test surface. The transfer tube has an inlet end for receiving a volatized sample into an interior of the transfer tube and an outlet end for directing the volatized sample from the interior of the transfer tube. The sampling head is coupled to the inlet end of the transfer tube and has a volatilized sample receiving area defined by a distal end that is configured to be brought into contact with the test surface and an opening in the sampling head that is in fluid communication with the inlet end of the transfer tube. The distal end of the sampling head includes a porous metallic membrane.

### ACKNOWLEDGMENT OF GOVERNMENT SUPPORT

This invention was made with government support under Contract No. DE-AC05-000R22725 awarded by the U.S. Department of Energy. The government has certain rights in the invention.

### FIELD

The present disclosure relates generally to devices and methods for collecting volatilized samples of materials for identification and/or analysis, and, more particularly, to sampling heads for volatilizing materials from a test surface.

### BACKGROUND

Samples of known or unknown materials can be collected from various surfaces and transferred to diagnostic equipment capable of characterizing the collected sample. Such characterization can include, for example, analyzing and/or identifying one or more materials in the collected sample. Samples of material that are characterized using mass spectrometry or gas chromatography instruments are generally volatilized prior to delivery to the instrument. Accordingly, various sampling systems have been developed to volatilize samples of material and deliver the volatilized samples to the analytical instruments.

However, conventional sampling systems have many drawbacks. For example, many conventional sampling systems require significant sample preparation before a test can be performed on a volatilized sample. Lengthy sample preparation requirements can restrict the practicality and/or desirability of such sampling systems in situations where a rapid response is desired, including, for example, situations in which on-site analysis is to be performed. Other drawbacks include, for example, the use of materials in the sampling system that restrict or delay the flow of volatilized materials from the sampling system to the analytical instrument. Conventional sampling systems also generally require that the sample be collected and delivered to a laboratory or other facility for analysis by an analytical instrument. Therefore, such conventional systems are unsuitable for collecting and analyzing samples in the field using portable analytical instruments. Accordingly, it is desirable to provide improved sampling systems and methods that eliminate or reduce these and other drawbacks of conventional sampling systems.

### SUMMARY

In one embodiment, a sampling system for volatilizing a sample from a test surface to deliver the volatilized sample to an analytical instrument is provided. The system comprises a transfer tube and a sampling head. The transfer tube has an inlet end for receiving a volatized sample into an interior of the transfer tube and an outlet end for directing the volatized sample from the interior of the transfer tube. The sampling head is coupled to the inlet end of the transfer tube and has a volatilized sample receiving area defined by a distal end that is configured to be brought into contact with the test surface and an opening in the sampling head that is in fluid communication with the inlet end of the transfer tube. The distal end of the sampling head can comprise a porous metallic membrane.

In some embodiments, each of the exposed surfaces in the volatilized sample receiving area is formed with substantially vapor-impermeable materials. The porous metallic membrane of the sampling head can be comprised of stainless steel and, in some embodiments, is a non-woven structure. In some embodiments, the surface of the transfer tube interior is coated with an inert material. In some embodiments, the transfer tube comprises a stainless steel tube. A heating element can be provided to resistively heat the stainless steel tube to a temperature between 120 and 250 degrees Celsius.

In other embodiments, sampling head includes at least one heating element disposed adjacent the porous metallic membrane. The heating element can be configured to heat the porous metallic membrane to a temperature that is between 140 and 250 degrees Celsius. In some embodiments, the sampling head and the transfer tube can be heated independently of one another to temperatures between 140 and 250 degrees Celsius. In other embodiments, an analytical instrument is coupled to the outlet end of the transfer tube. The analytical instrument can be a mass spectrometer.

In another embodiment, a sampling head for volatilizing a sample from a test surface is provided. The sampling head can comprise a distal end comprising a porous metallic membrane, a membrane support member, and a connector. The porous metallic membrane can be configured to be brought into contact with the test surface. The membrane support member can have a first side that faces the porous metallic membrane, with the first side having a recessed portion that is configured to direct the volatilized sample towards an opening in the first side. The connector can extend from a second side of the membrane support member and be in fluid connection with the opening in the first side. The second side can be opposite the first side and the connector can be configured to be coupled to an inlet end of a transfer tube. A volatilized sample receiving area can be provided in the sampling head between the distal end of the sampling head and the first side of the membrane support member. All exposed surfaces in the volatilized sample receiving area can consist essentially of vapor-impermeable materials. Thus, the volatilized sample receiving area can be formed in the absence of vapor-permeable materials so that the volatilized sample is in direct contact with only vapor-impermeable materials.

In some embodiments, the porous metallic membrane of the sampling head can comprise stainless steel and/or a non-woven structure. In other embodiments, at least one heating element can be disposed adjacent the porous metallic membrane and the heating element can be configured to heat the porous metallic membrane to a temperature that is between 140 and 250 degrees Celsius. The heating elements can be a pair of cartridge heaters disposed on the second side of the membrane support member.

In another embodiment, a method of collecting a volatilized sample from a test surface is provided. The method can include heating a distal end of a sampling head to a temperature of between 140 and 250 degrees Celsius and positioning a porous metallic membrane at the distal end of the sampling head in contact with the test surface. A sample from the test surface can be volatilized and directed into a volatilized sample receiving area. The volatilized sample receiving area can be a volume of area in the sampling head between the distal end of the sampling head and an opening in the sampling head. The volatilized sample can be directed out of the sampling head through the opening in the sampling head. Each of the exposed surfaces in the volatilized sample receiving area can consist essentially of vapor-impermeable materials. Thus, the volatilized sample receiving area can be formed in the absence of vapor-permeable materials so that the volatilized sample is in direct contact with only vapor-impermeable materials.

In some embodiments, the porous metallic membrane can include a stainless steel membrane and the act of directing the volatilized sample into the volatilized sample receiving area can include directing the volatilized sample through the stainless steel membrane. In other embodiments, the volatilized sample can be directed into an inlet end of a transfer tube. The opening in the sampling head can be in fluid communication with the inlet end of the transfer tube and the volatilized sample can be directed through the interior of the transfer tube to an outlet end of the transfer tube. The volatilized sample can then be directed out of the outlet end of the transfer tube to a mass spectrometer. In other embodiments, the act of directing the volatilized sample through the interior of the transfer tube comprises directing the volatilized sample through a stainless steel tube that is coated with an inert material.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates a sampling head for use with a sampling system for collecting volatilized materials.

FIG. 2 illustrates an exploded view of the sampling head shown in FIG. 1.

FIG. 3 illustrates bottom perspective view of a screen holder for maintaining the position of a screen in the sampling head shown in FIG. 1.

FIG. 4A illustrates a top perspective view of a screen support member for use in the sampling head shown in FIG. 1.

FIG. 4B illustrates a bottom perspective view of the screen support member shown in FIG. 4A.

FIG. 5 illustrates a top perspective view of a heater cover for use in the sampling head shown in FIG. 1.

FIG. 6 illustrates a side perspective view of an insulation member for use in the sampling head shown in FIG. 1.

FIG. 7 illustrates a front perspective view of a flexible member for use in the sampling head shown in FIG. 1.

FIG. 8 illustrates a portion of a sampling head for use with the sampling systems described herein.

FIG. 9 illustrates a sampling system that includes a sampling head coupled to a transfer line for collecting volatilized materials.

FIG. 10 illustrates a portion of a sampling system coupled to a stationary tool for receiving samples of material for volatilization on a fixed surface.

FIG. 11 illustrates a calibration performed using a sampling system that comprises a sampling head as shown and described with respect to FIGS. 1 and 2

FIG. 12 illustrates the results of a scan performed on a sample captured by volatizing an amount of sulfur mustard agent (HD) on a painted gypsum wallboard surface.

FIG. 13 illustrates the results of a scan performed on a sample captured by volatizing an amount of HD on a vinyl tile surface.

FIG. 14 illustrates the results of a scan performed on a sample captured by volatizing an amount of HD on an escalator handrail surface.

FIG. 15 illustrates a calibration performed using a sampling system that comprises a sampling head as shown and described with respect to FIGS. 1 and 2.

FIG. 16 illustrates the results of a scan performed on a sample captured by volatizing an amount of sarin (GB) from TexWipes®.

FIG. 17 illustrates the results of a scan performed on a sample captured by volatizing an amount of GB on an escalator handrail surface.

FIG. 18 illustrates the results of a scan performed on a sample captured by volatizing an amount of GB on an escalator belt surface.

FIG. 19 illustrates the results of a scan performed on a sample captured by volatizing an amount of GB on a vinyl tile surface.

FIG. 20 illustrates a calibration performed using a sampling system that comprises a sampling head as shown and described with respect to FIGS. 1 and 2.

FIG. 21 illustrates the results of a scan performed on the CBMS-II using a known amount of nerve agent (VX) on a stainless steel surface.

### DETAILED DESCRIPTION

Various embodiments of sampling systems and their methods of use are disclosed herein. The following description is exemplary in nature and is not intended to limit the scope, applicability, or configuration of the invention in any way. Various changes to the described embodiments may be made in the function and arrangement of the elements described herein without departing from the scope of the invention.

As used in this application and in the claims, the singular forms “a,” “an,” and “the” include the plural forms unless the context clearly dictates otherwise. Additionally, the term “includes” means “comprises.” Further, the term “coupled” generally means electrically, electromagnetically, and/or physically (e.g., mechanically or chemically) coupled or linked and does not exclude the presence of intermediate elements between the coupled or associated items absent specific contrary language.

Unless otherwise indicated, all numbers expressing quantities of ingredients, properties such as molecular weight, percentages, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, the term “proximal” means in a direction towards an analytical instrument or towards an end of the sampling system where an analytical instrument can be coupled. As used herein, the term “distal” means in a direction away from the analytical instrument or away from the end of the sampling system where an analytical instrument can be coupled. As used herein, the term “volatilize” means the conversion of a chemical substance from a liquid or solid state to a gaseous or vapor state by the application of heat, by reducing pressure, or by a combination of these processes. Materials that can be volatilized include volatile and semi-volatile materials, which can be volatilized in whole or in part.

As understood by one or ordinary skill in the art, materials have a moisture vapor transmission rate that can be established by standard test methods. Perms are a measure of the rate of transfer of water vapor through a material (1.0 US perm=1.0 grain/square-foot·hour·inch of mercury≈57 SI perm=57 ng/s·m2·Pa). Vapor retarding materials are generally categorized as impermeable (≦1 US perm, or ≦57 SI perm), semi-permeable (1-10 US perm, or 57-570 SI perm), and permeable (>10 US perm, or >570 SI perm). As used herein, the term “vapor-permeable material” means a material that has an external surface which allows a volatilized material to physically pass through the external surface and that has a permeance of greater than 10 perms. Vapor-permeable materials include, for example, such materials as silicone rubber, neoprene, and fluoroelastomers (e.g., Viton®). As used herein, the term “vapor-impermeable material” means a material that has an external surface which substantially prevents a volatilized material from physically passing through the external surface and that has a permeance of less than 10 perms. Vapor-impermeable materials include impermeable and semi-permeable materials, such as stainless steel.

Although the operations of exemplary embodiments of the disclosed method may be described in a particular, sequential order for convenient presentation, it should be understood that the disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

Certain of the sampling systems disclosed herein comprise heated porous metallic membranes configured to be positioned adjacent various test surfaces to volatilize samples of material from the test surfaces for further analysis. As used herein, the term “test surface” means any surface from which a sample can be obtained. In some embodiments, the heated porous metallic membrane can extend beyond a distal end of a sampling head so that the heated porous metallic membrane can make direct contact with the test surface. Once volatilized, at least a portion of the volatilized sample can be transferred through an inert transfer tube of a transfer line to an analytical instrument (e.g., a mass spectrometer) for characterization. In some embodiments, the inert transfer tube is also heated.

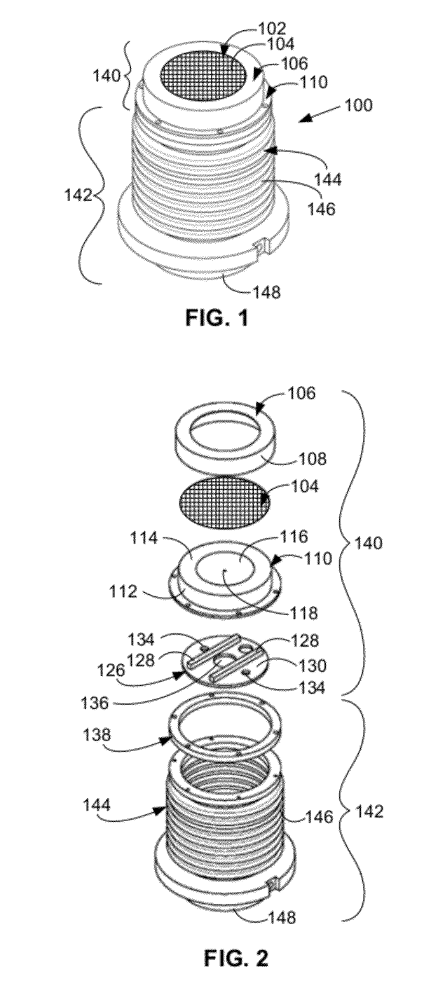

FIGS. 1 and 2 illustrate a sampling head 100 that can be used with a sampling system to volatilize a sample of material from a test surface. FIG. 1 illustrates a front perspective view of sampling head 100 and FIG. 2 illustrates an exploded view of sampling head 100. Sampling head 100 comprises a porous sampling surface 102 that is adapted to be placed on or adjacent to a test surface that contains the material that is to be sampled. In some embodiments, porous sampling surface 102 comprises a distal end portion of sampling head 100 so that when the distal end portion of sampling head 100 is brought into contact with the test surface, porous sampling surface 102 is also in contact with the test surface.

Sampling surface 102 can comprise a porous metallic screen 104. In some embodiments, porous metallic screen 104 can be a stainless steel mesh. Desirably, the stainless steel mesh comprises a non-woven mesh structure. Although screen 104 is preferably formed of a stainless steel mesh, other chemically inert metallic members, such as various nickel alloys or steels, may be suitable for use in certain applications. To reduce absorption and/or diffusion of volatilized materials into and/or through the material of screen 104, screen 104 is preferably formed without any surfaces that are vapor-permeable. Accordingly, in some embodiments, screen 104 consists essentially of vapor-impermeable materials such as stainless steel. Thus, screen 104 can be formed in the absence of vapor-permeable materials such as silicone rubber.

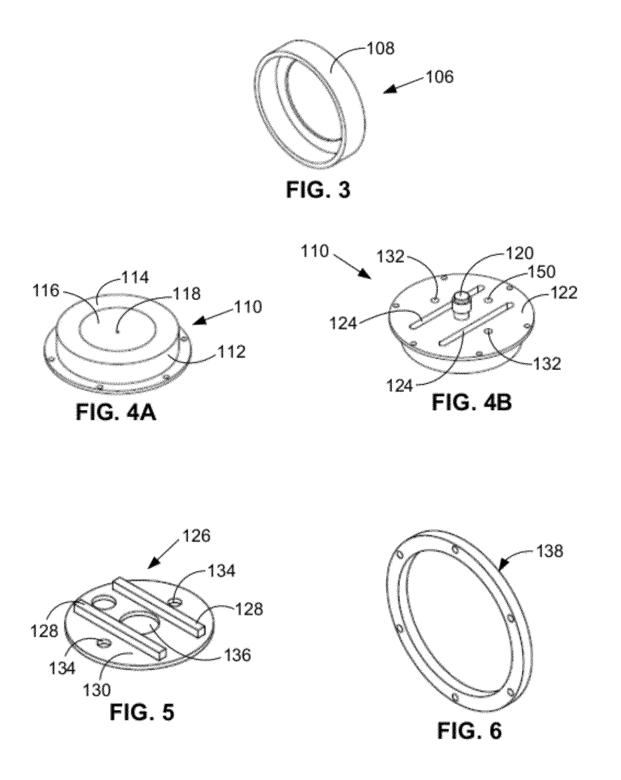

Screen 104 can be maintained at the distal end portion of sampling head 100 using a screen holder 106 that captures and secures at least a portion of screen 104 to sampling head 100. Screen holder 106 can comprise a metallic nut or other such element that has an opening through which at least a portion of screen 104 can be exposed and/or extend. FIG. 3 illustrates a perspective view of screen holder 106. If desired, screen holder 106 can have an external side surface 108 that is knurled (FIG. 8) or otherwise modified to improve the ability of a user to grasp the external side surface 108 to facilitate the removal of screen holder 106 to provide access to screen 104.

Screen 104 can be sized to be received (e.g., sandwiched) between at least a portion of screen holder 106 and an opposing screen support member 110. Screen support member 110 can include an extending portion 112 that has a generally ring-shaped upper surface 114 on which a portion of screen 104 can be supported. Screen 104 can be secured to sampling head 100 by positioning screen 104 on upper surface 114 and securing screen holder 106 (e.g., a knurled nut) over screen 104. If necessary, one screen can be removed and replaced with another screen by removing screen holder 106 from screen support member 110, removing screen 104 from upper surface 114, positioning a new screen 104 on upper surface 114, and reattaching screen holder 106 to screen support member 110. Screen holder 106 can be secured to screen support member 110 in any known manner, including, for example, by mating respective threaded portions in screen holder 106 and screen support member 110 or by otherwise achieving an interference fit between the two elements.

Upper surface 114 of screen support member 110 can generally surround a recessed portion 116. Recessed portion can have an opening 118 that passes through screen support member 110 to allow the passage of volatilized materials through screen support member 110. Recessed portion 116 can be somewhat concave or otherwise funnel-shaped to help direct volatilized materials that pass through screen 104 towards opening 118. Alternatively recessed portion 116 can be substantially flat.

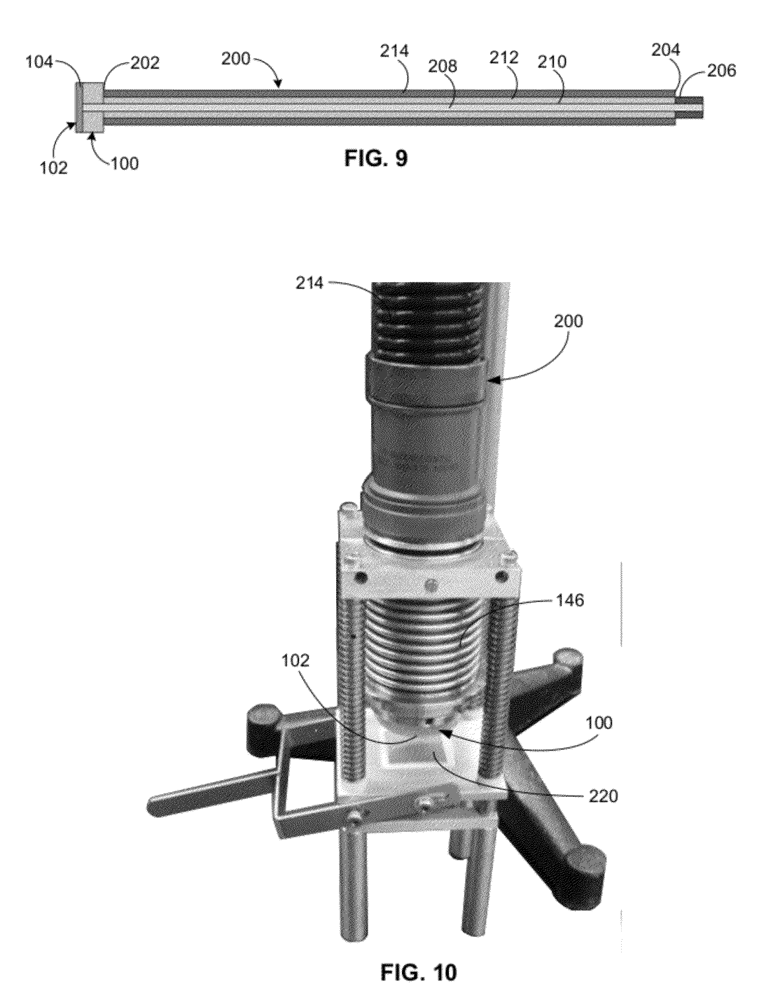

FIGS. 4A and 4B illustrate additional views of screen support member 110, with FIG. 4A showing a top perspective view and FIG. 4B showing a bottom perspective view. As discussed above, opening 118 allows volatilized materials to flow through screen support member 110 to a transfer line 200 (FIG. 9). A tube connector 120 can extend from a bottom surface 122 of screen support member 110. Tube connector 120 can be in fluid communication with opening 118 so that transfer line 200 (FIG. 9) can be coupled to tube connector 120 to fluidly connect opening 118 with transfer line 200. Tube connector 120 can comprise any suitable coupling member, such as, for example, a Swagelok® tube fitting.

A volume (e.g., area or space) within sampling head 100 between the distal end of sampling head 100 and opening 118 can be referred to as the volatilized sample receiving area. This volume can extend across the width of sampling surface 102 at the distal end and extend proximally toward opening 118 and include all of the exposed surfaces between the distal end of sampling head 100 and opening 118. Thus, the volatilized sample receiving area can include all surfaces within sampling head 100 that are exposed to the volatilized sample before the volatilized sample exits opening 118 for delivery to the analytical instrument.

All of the exposed surfaces in the volatilized sample receiving area are preferably formed of vapor-impermeable materials to reduce the absorption and/or diffusion of volatilized materials into or through of the structures that are exposed within the volatilized sample receiving area. By eliminating the use of vapor-permeable materials in the exposed, internal surfaces in sampling head 100, the sampling heads disclosed herein are capable of providing rapid analysis of materials obtained from various surfaces. In some embodiments, the vapor-impermeable materials do not include any semi-permeable materials.

In operation, when exposed surfaces in the volatilized sample receiving area are formed only with vapor-impermeable materials (i.e., without any vapor-permeable materials), the volatilized materials collected by sampling head 100 pass through the distal end (including screen 104) of sampling head 100 to opening 118, and exit sampling head 100 via transfer line 200. Substantially none of the volatilized materials diffuse through any internal portion of the materials of sampling head 100 itself prior to delivery to transfer line 200. In some embodiments, each of the exposed internal surfaces in the volatilized sample receiving area is formed of stainless steel. In other embodiments, some or all of the exposed internal surfaces in the volatilized sample receiving area consist essentially of vapor-impermeable materials. For example, all of the exposed surfaces of screen 104 and/or all of surfaces of screen support member 110 that face screen 104 can consist essentially of vapor-impermeable materials (e.g., stainless steel). It should be understood that, in this context, the term “all of the exposed surfaces of screen 104” refers to each exposed surface of the individual strands or elements that comprise the materials that form screen 104.

In contrast, conventional sampling heads generally incorporate vapor-permeable materials that slow the passage of volatilized materials by absorbing and/or diffusing the volatilized materials during a sampling step. Such vapor-permeable materials can include, for example, silicone rubber incorporated adjacent to, or integrally with, a screen or mesh member. The inclusion of vapor-permeable materials in the sampling head was believed to be beneficial to provide improved structural integrity without interfering with the operation of the sampling head. However, it has been found that the diffusion of volatilized materials through the silicone rubber and other such vapor-permeable materials undesirably delays the delivery of the volatized materials to the analytical instrument, which can increase the time required for analysis of the volatilized sample. Also, such delays adversely affect detection limits by reducing the amount of volatilized materials delivered to the analytical instrument and/or spacing the arrival of volatized material at the analytical instrument. Moreover, the absorption of volatilized materials by vapor-permeable portions or surfaces of a sampling head in the pathway of the delivery of the volatilized materials to the analytical instruments (i.e., in a volatilized sample receiving area) can affect the results of subsequent tests in which absorbed materials are later re-volatilized from the vapor-permeable portions.

Accordingly, certain embodiments of the sampling heads disclosed herein provide improved sample delivery characteristics by eliminating the exposure of volatilized materials to silicone rubber and/or other vapor-permeable materials within the volatilized sample receiving areas of sampling head 100.

One or more heating elements can be positioned adjacent screen 104 to heat sampling surface 102 and volatilize materials that are in contact with, or positioned adjacent to, sampling surface 102. As shown in FIG. 4B, bottom surface 122 of screen support member 110 can comprise one or more heater receiving areas 124 for receiving one or more heating elements (not shown). The heating elements can comprise cartridge heaters that are sized to be received within heater receiving areas 124.

A heater cover 126 can be provided proximal to screen support member 110 to retain the heating elements (e.g., cartridge heaters) in receiving areas 124. For example, one or more retaining members 128 can extend distally from an upper surface 130 of heater cover 126 and, when heater cover 126 is coupled to screen support member 110, the upper surfaces of retaining members 128 can engage with the heating elements and secure them within their respective heater receiving areas 124. Heater cover 126 can be coupled to screen support member 110 in any conventional manner, including, for example, by securing one or more fasteners through openings 132, 134, in screen support member 110 and heater cover 126, respectively. As shown in FIG. 5, heater cover 126 can have an opening 136 sized to receive a portion of tube connector 120 that extends proximally through screen support member 110 when screen support member 110 is coupled to heater cover 126.

As shown in FIGS. 2 and 6, an insulating member 138 (e.g., thermally insulating gasket) can be positioned proximal to heater cover 126. Insulating member 138 is made from thermally insulating materials (e.g., ceramic) that can reduce the amount of heat transferred from a heated portion 140 (i.e., a portion that includes sampling surface 102 and adjacent members) to an unheated portion 142 (i.e., a portion that includes members located proximal to insulating member 138) of sampling head 100. Insulating member 138 can therefore improve the efficiency of the operation of sampling head 100 by reducing the amount of heat that is lost from the heated portion 140 of sampling head 100. In some embodiments, insulating member 138 can be a polymeric material with low thermal conductivity and high working temperature such as Vespel®, polybenzimidazole, or glass-filled polytetrafluoroethylene (PTFE).

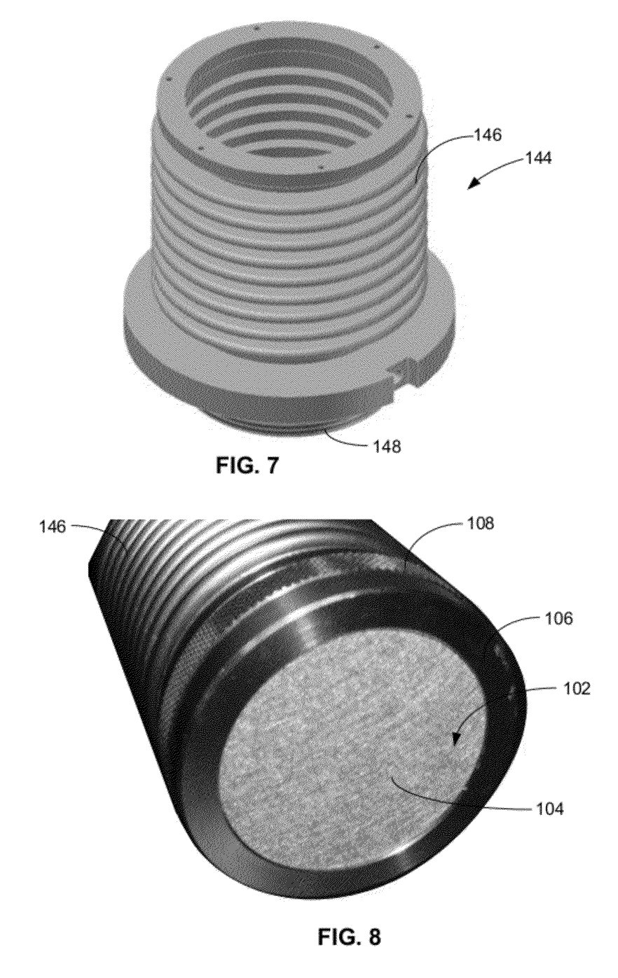

The unheated portion 142 of sampling head 100 can include a flexible member 144. Flexible member 144 can include a coupling portion 148 that is configured to receive a distal portion of transfer line 200 to couple sampling head 100 to transfer line 200 (FIG. 9). As shown best in FIGS. 7 and 8, flexible member 144 can comprise a flexible stainless steel portion 146. In some embodiments, flexible member 144 is a bellows- or accordion-type member that allows flexible member 144 to bend and/or stretch in various directions. The ability of flexible member 144 to bend and/or stretch allows sampling head 100 to be more easily positioned so that sampling surface 102 makes substantially flat contact with a test surface. By making substantially flat contact with the test surface, at least a partial seal can be achieved between an outer ring of the distal end of sampling head 100 (e.g., the area of sampling head 100 that surrounds screen 104) and the portion of the test surface positioned thereunder. This partial seal can improve the transfer of heat from sampling surface 102 to the test surface and/or provide improved flow of the volatilized sample from the test surface into the volatilized sample receiving area of sampling head 100. In addition, because flexible member 144 is in the unheated portion 142 of sampling head 100, a user can contact and maneuver the flexible member 144 to achieve the substantially flat contact with the test surface without significant risk of being burned or experiencing significant discomfort due to the temperature of flexible member 144.

As described above, sampling head 100 can be heated via heating members (e.g., cartridge heaters) received in the heated portion 140 of sampling head 100. One or more temperature sensors can also be provided in the heated portion 140 to monitor the temperature of the heated portion 140. For example, a resistance temperature detector (RTD) can be coupled to screen support member 110 via a fastener received in a mounting opening 150. Thus, the temperature of the heated portion 140 can be monitored to control the heat output of the heating elements to sampling surface 102. In some embodiments, sampling surface 102 can be heated to temperatures between about 125 degrees Celsius and 250 degrees Celsius, and more preferably between about 140 and 250 degrees Celsius, depending on the temperatures required for volatilization of the materials to be characterized.

Referring to FIG. 9, the sampling system can also include a transfer line 200 coupled to sampling head 100 to receive the volatilized sample and direct it to the analytical device. As shown in FIG. 9, transfer line 200 comprises an inlet end 202 and an outlet end 204. The inlet end 202 of transfer line 200 can be coupled to sampling head 100 and the outlet end 204 of transfer line 200 can be configured to be coupled to an analytical instrument, such as a mass spectrometer (not shown). To facilitate the coupling of the outlet end 204 with the analytical instrument, a connector 206 can be coupled to the outlet end 204 of transfer line 200. Transfer line 200 can comprise a stainless steel transfer tube 208 that extends from the inlet end 202 of transfer line 200 to the outlet end 204 of transfer line 200. Materials that are heated and volatilized by sampling head 100 can be directed to the inlet end 202 of transfer line 200 and directed through an interior lumen of transfer tube 208 to the analytical instrument.

Transfer tube 208 can have one or more coatings applied to its internal surfaces to reduce surface absorption of volatilized materials. For example, transfer tube 208 can comprise a tube that is treated with an inert material, such as Sulfinert® or Silcosteel®. In some embodiments, transfer tube 208 can also be heated to maintain the materials in their vapor state as they are delivered through transfer tube 208. To heat transfer tube 208 along its length, an electric current can be passed through transfer tube 208, thereby resistively heating transfer tube 208 to a desired temperature. The transfer tube can be heated to various desired temperatures, including, for example, to temperature between 120 and 250 degrees Celsius. The electric current can be delivered to transfer tube 208 via one or more wires that are positioned to contact transfer tube 208 and form an electric circuit through which current can flow.

Transfer tube 208 can be insulated to reduce heat loss from transfer tube 208 and to reduce safety risks associated with having an exposed heated tube. The insulation of transfer tube 208 can be achieved by providing one or more layers of electrical insulation around an outer surface of transfer tube 208 along at least a portion of its length. In one embodiment, transfer tube 208 extends within a sheath 210 that is formed of an insulating material such as Teflon™. Transfer tube 208 can be longitudinally movable relative to sheath 210. Such relative movement can allow transfer tube 208 to be removed from sheath 210 to allow replacement and/or repair of transfer tube 208 if necessary and/or desired. A second layer 212 of insulating material can surround sheath 210. Second layer 212 can comprise, for example, a layer of Pyropel® to further insulate heated transfer tube 208.

A flexible conduit 214 can surround second layer 212. Flexible conduit can be a piece of flexible plastic that is configured to retain the various elements of transfer line 200 and allow bending and flexing of transfer line 200. In some embodiments, flexible conduit 214 can comprise a coiled flexible member. Wiring elements and/or other heat sensitive elements can be positioned between second layer 212 and flexible conduit 214. By placing wiring elements (and other heat sensitive members) radially external to the insulation layers (e.g., sheath 114 and/or second layer 116), the wiring elements can be insulated and protected from the heat generated by the resistive heating of transfer tube 208. The wiring elements that can be positioned external to the insulation along at least a portion of their length include, for example, the wiring that provides the electric current to resistively heat transfer tube 208 and the wiring that controls and/or receives information from components in the heated portion 140 of sampling head 100, such as any temperature sensors (e.g., an RTD) or heating elements (e.g., cartridge heaters) positioned therein.

In operation, the sampling system can be used to volatilize samples from a surface by moving the sampling surface 102 of sampling head into contact with the test surface. The maneuverability of sampling head 100 resulting from the ability of flexible member 144 to bend or stretch allows sampling surface 102 to be positioned at or adjacent to a wide variety of surface shapes and types. In addition, the flexibility of transfer line 200 allows sampling head 100 to be more easily maneuvered into a desired position adjacent the test surface.

Such maneuverability of sampling head and the transfer line can be particularly helpful when sampling surfaces for chemical weapons (CW) and toxic industrial chemicals (TICs), which, in some circumstances, is performed outside the laboratory environment on a variety of existing surfaces. For example, it can be preferable to sample for CW from various surfaces in in public facilities such as airports and other transit stations.

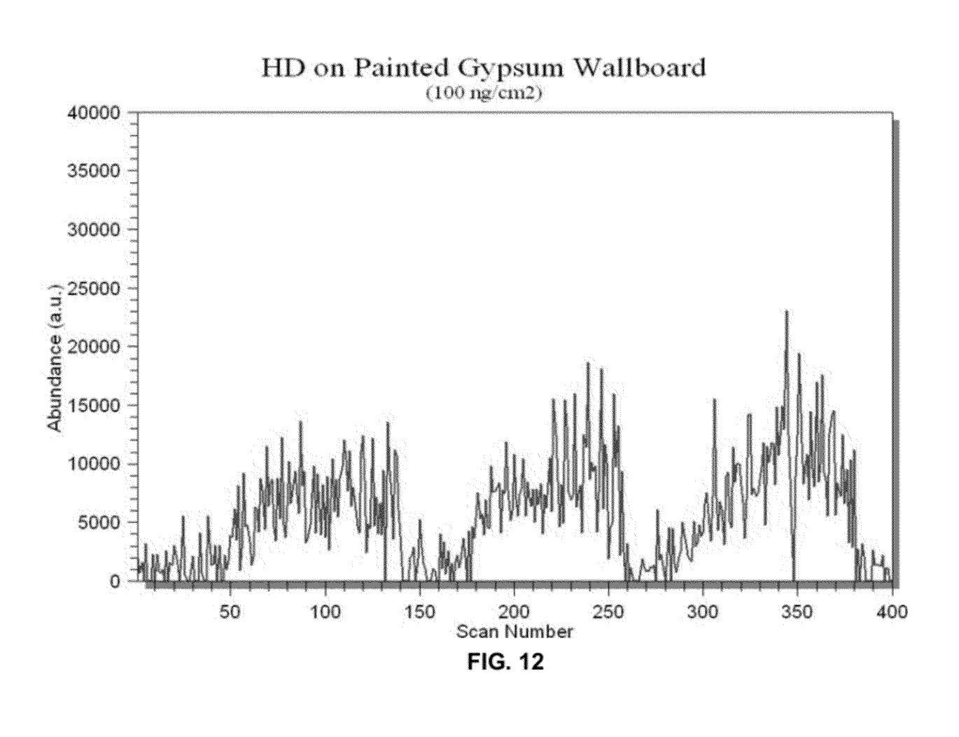

The sampling systems disclosed herein can be particularly helpful in characterizing organic analytes associated with CW and TICs. In some embodiments, the sampling systems disclosed herein can be operated with mobile mass spectrometers further facilitating on-site use and reducing the need for sample collection, transport, and chain-of-custody requirements. However, it should be understood that the sampling systems disclosed herein are also suitable for use in a laboratory setting and, in the case where a sample surface is not accessible by the sampling surface of the sampling head, conventional wipes or other such sample transfer means can be used to deliver the sample to the sampling surfaces of the sampling systems disclosed herein. For example, as shown in FIG. 12, the sampling systems disclosed herein can be coupled to a stationary device for analyzing materials positioned on a fixed surface 220.

Sampling surface 102 of sampling head 100 can be brought into contact with the test surface for a sufficient period of time to volatilize the desired material that is present on (or thought to be present on) the surface. In some embodiments, sampling surface 102 can be applied to the surface for about 30 seconds to 120 seconds. When the surface is a substantially hard surface, such as glass or steel, sampling surface 102 can be applied to the surface for a shorter period of time (e.g., about 40 to 45 seconds) and when the surface is an organic material, such as an rubber or vinyl material, sampling surface 102 can be applied to the surface for a longer period of time (e.g., about 60 to 90 seconds). The following examples illustrate the ability of the sampling systems disclosed herein to accurately detect low abundances of volatilized materials from various surfaces.

### EXAMPLE 1

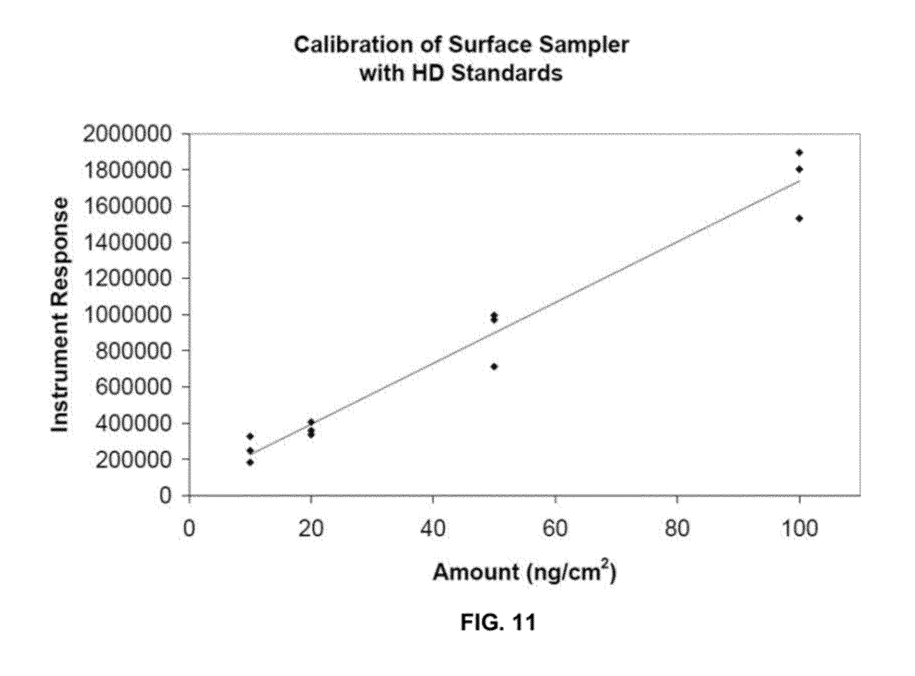

FIG. 11 illustrates a calibration performed using a sampling system that comprises a sampling head as shown and described above with respect to FIGS. 1 and 2, and a transfer line as shown and described above with respect to FIG. 9. The sampling system was coupled to a Block II chemical biological mass spectrometer (CBMS-II). The calibration shown in FIG. 11 was performed by applying known amounts of a blister agent, namely distilled sulfur mustard agent (HD), to a surface, volatilizing at least a portion of the HD sample using the sampling system, and scanning the volatilized HD portion using the CBMS-II.

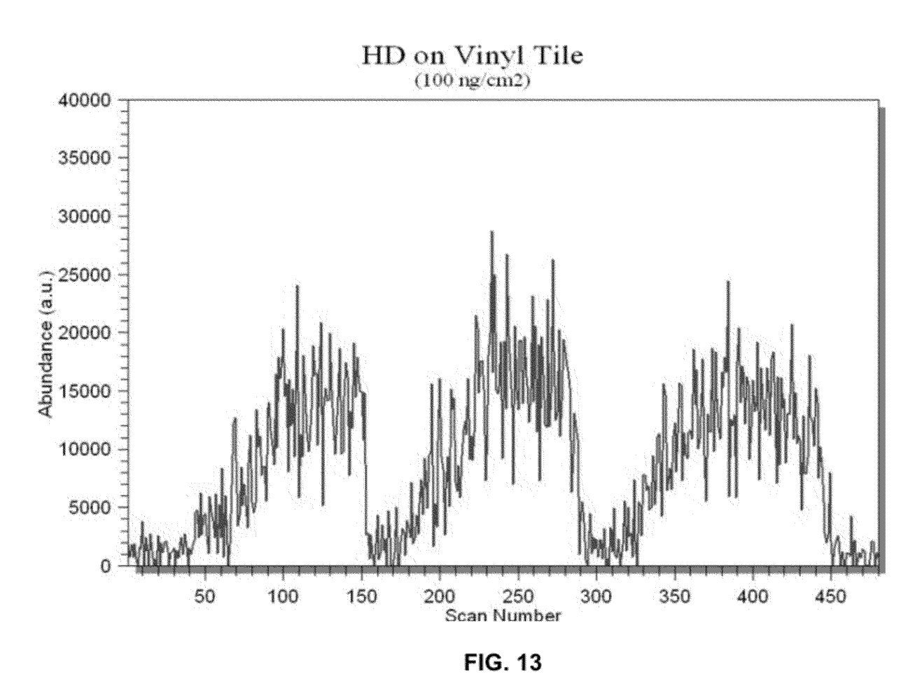

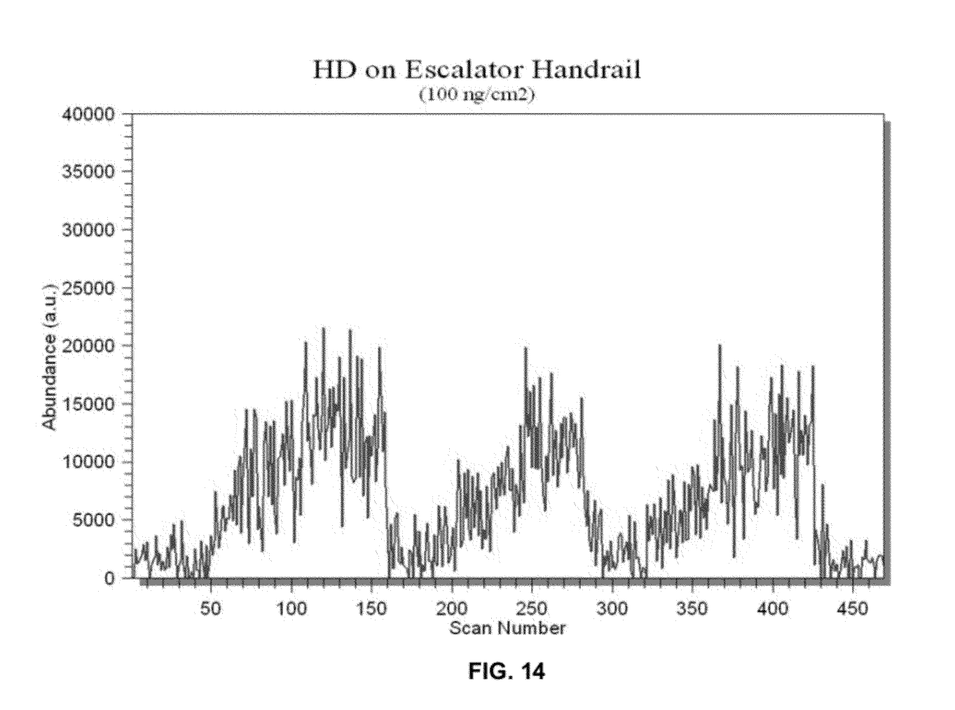

FIGS. 12-14 illustrate the results of scans performed on the CBMS-II using known amounts of HD on various surfaces. FIG. 12 illustrates the results of a scan performed on a sample captured by volatizing an amount of HD on a painted gypsum wallboard surface. FIG. 13 illustrates the results of a scan performed on a sample captured by volatizing an amount of HD on a vinyl tile surface. FIG. 14 illustrates the results of a scan performed on a sample captured by volatizing an amount of HD on an escalator handrail surface.

The samples were volatilized from these surfaces by heating the sampling surface (i.e., the heating element of the sampling head) to a temperature of about 140-150 degrees Celsius and heating the stainless steel transfer tube to a temperature of about 160 degrees Celsius. For each of the test surfaces, the sampling surface of the sampling head was maintained in contact with the test surface for a period of about 1 minute to 1.5 minutes.

### EXAMPLE 2

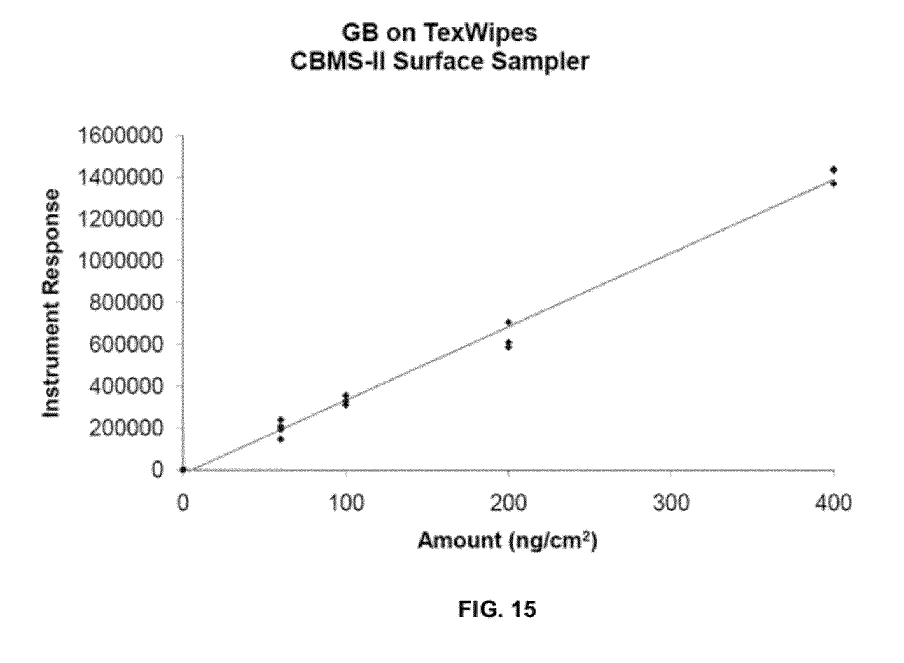

FIG. 15 illustrates a calibration performed using a sampling system that comprises a sampling head as shown and described above with respect to FIGS. 1 and 2, and a transfer line as shown and described above with respect to FIG. 9. The sampling system was coupled to a Block II chemical biological mass spectrometer (CBMS-II). The calibration shown in FIG. 15 was performed by applying known amounts of sarin (GB) to a surface, volatilizing at least a portion of the GB sample using the sampling system, and scanning the volatilized GB portion using the CBMS-II.

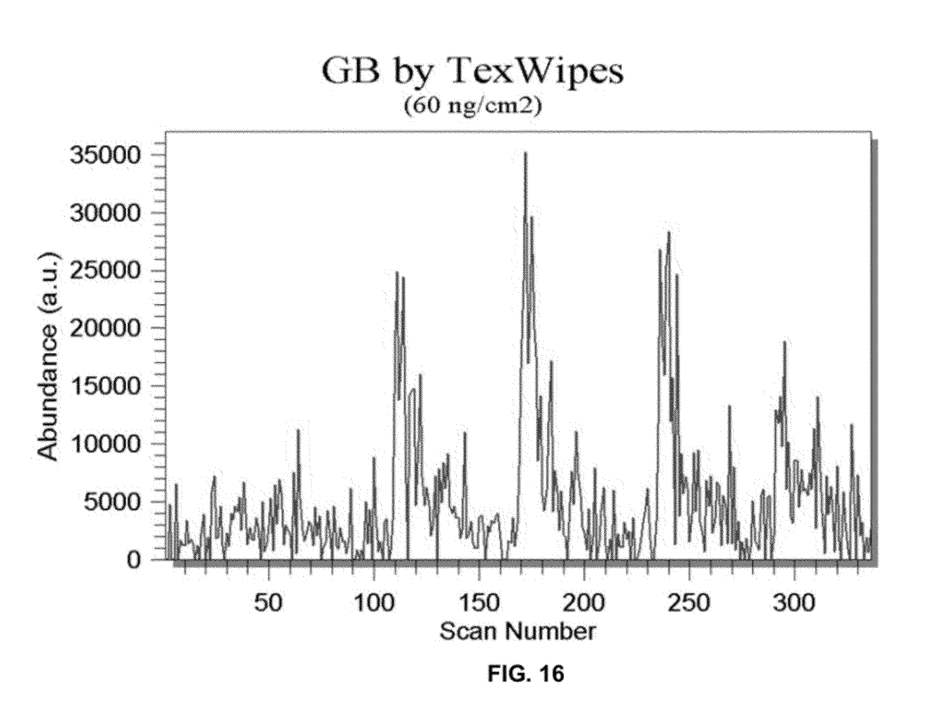

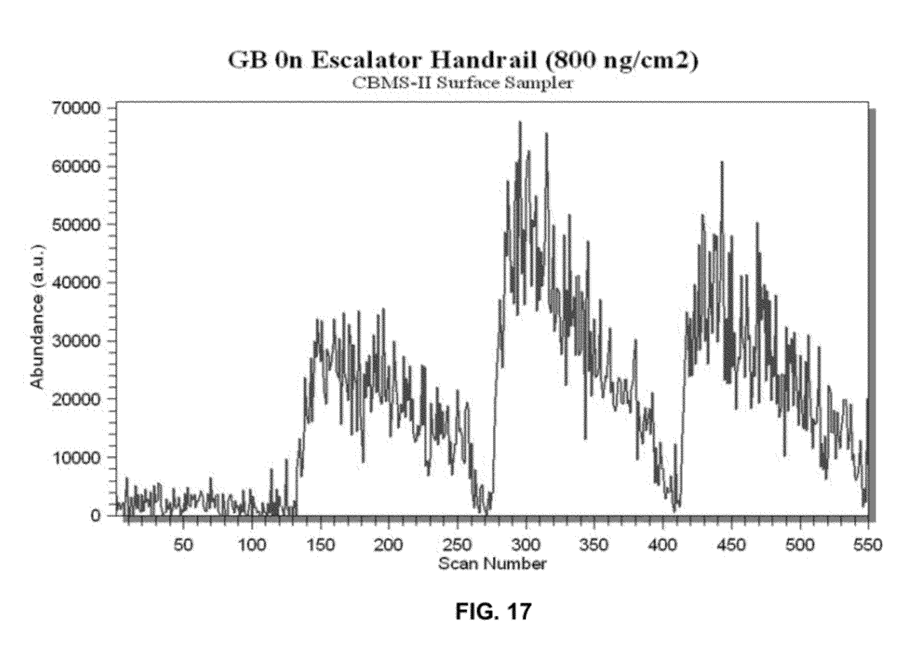

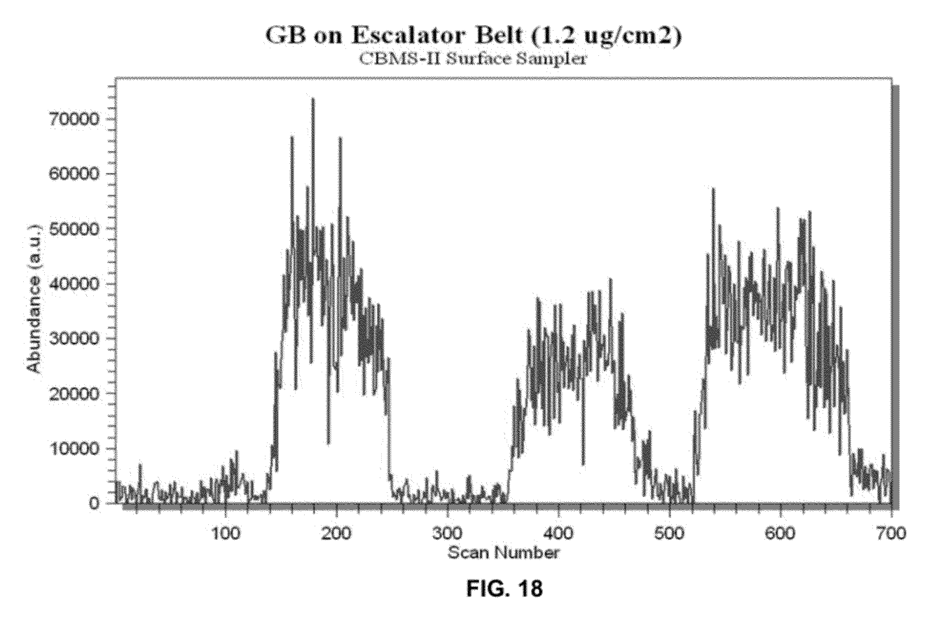

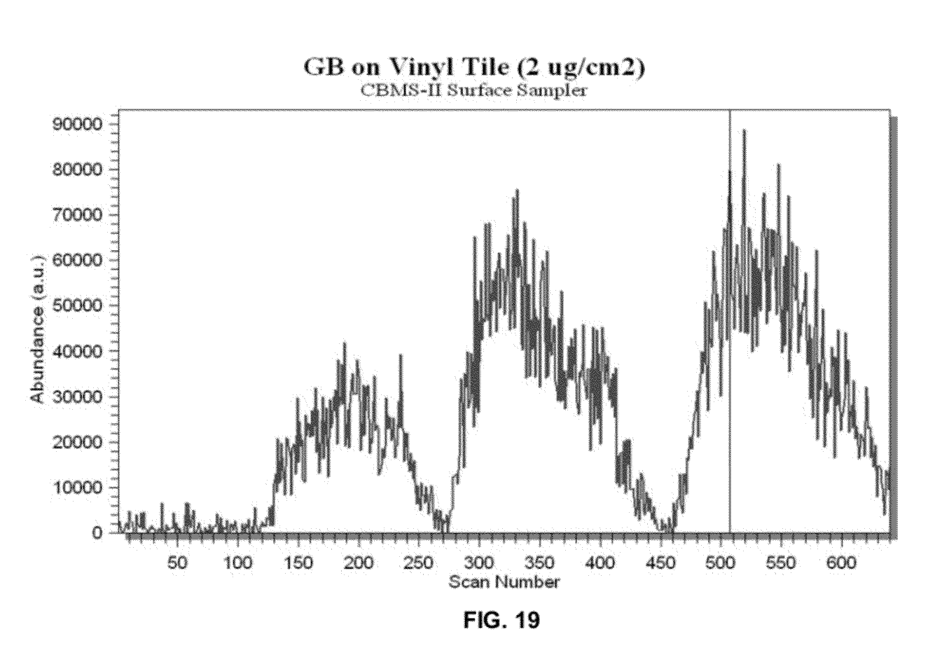

FIGS. 16-19 illustrate the results of scans performed on the CBMS-II using known amounts of GB on various surfaces. FIG. 16 illustrates the results of a scan performed on a sample captured by volatizing an amount of GB off of TexWipes®. FIG. 17 illustrates the results of a scan performed on a sample captured by volatizing an amount of GB on an escalator handrail surface. FIG. 18 illustrates the results of a scan performed on a sample captured by volatizing an amount of GB on an escalator belt surface. FIG. 19 illustrates the results of a scan performed on a sample captured by volatizing an amount of GB on a vinyl tile surface.

The samples were volatilized from the test surfaces by heating the sampling surface (i.e., the heating element of the sampling head) to a temperature of about 130 degrees Celsius and heating the stainless steel transfer tube to a temperature of about 140 degrees Celsius. For each of the test surfaces, the sampling surface of the sampling head was maintained in contact with the surface for a period of about 1 minute to 1.5 minutes.

### EXAMPLE 3

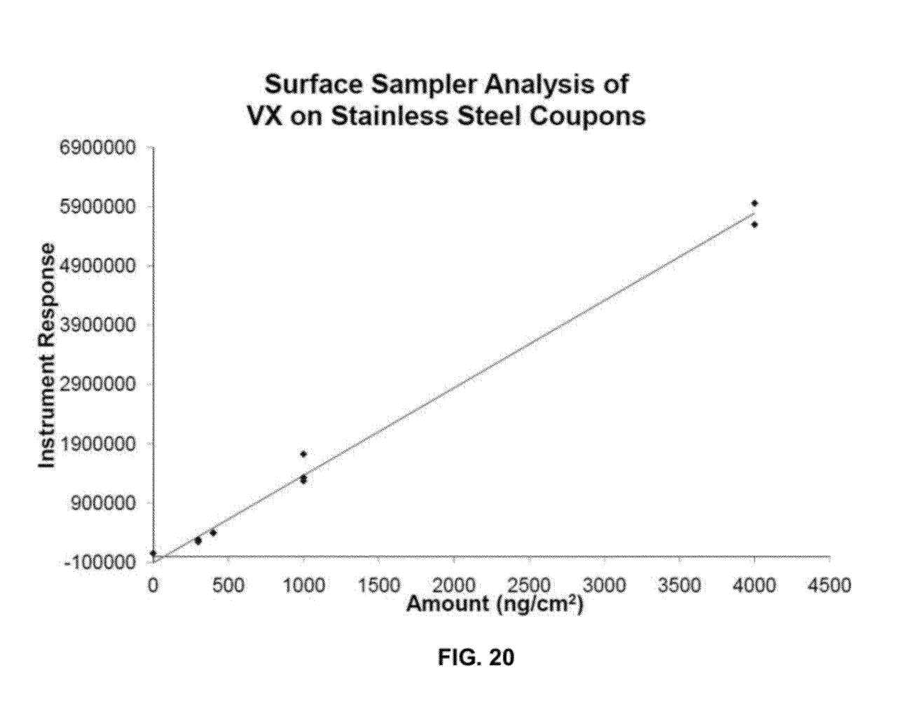

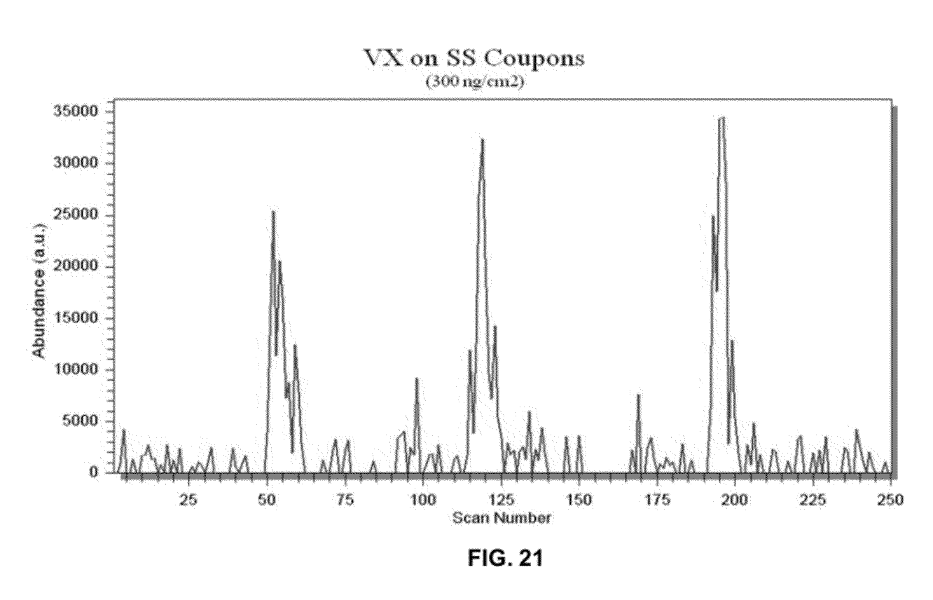

FIG. 20 illustrates a calibration performed using a sampling system that comprises a sampling head as shown and described above with respect to FIGS. 1 and 2, and a transfer line as shown and described above with respect to FIG. 9. The sampling system was coupled to a Block II chemical biological mass spectrometer (CBMS-II). The calibration shown in FIG. 20 was performed by applying known amounts of nerve agent (VX) to a surface, volatilizing at least a portion of the VX sample using the sampling system, and scanning the volatilized VX portion using the CBMS-II. FIG. 21 illustrates the results of a scan performed on the CBMS-II using a known amount of VX on a stainless steel surface.

The sample was volatilized from the test surface by heating the sampling surface (i.e., the heating element of the sampling head) to a temperature of about 230 degrees Celsius and heating the stainless steel transfer tube to a temperature of about 230 degrees Celsius. For this surface, the sampling surface of the sampling head was maintained in contact with the test surface for a period of about 40-45 seconds.

Accordingly, the sampling systems and methods of using the same disclosed herein provide various advantages over conventional systems and methods, including, for example, the ability to perform rapid on-site analysis with a high sample throughputs, while at the same time achieving low limits of detection and requiring little or no sample preparation.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A sampling system for volatilizing a sample from a test surface to deliver the volatilized sample to an analytical instrument, the system comprising:
a transfer tube having an inlet end for receiving a volatized sample into an interior of the transfer tube and an outlet end for directing the volatized sample from the interior of the transfer tube; and
a sampling head coupled to the inlet end of the transfer tube, the sampling head having a volatilized sample receiving area defined by a distal end that is configured to be brought into contact with the test surface and an opening in the sampling head that is in fluid communication with the inlet end of the transfer tube,
wherein the distal end of the sampling head comprises a porous metallic membrane.

2. The sampling system of claim 1, wherein each of the exposed surfaces in the volatilized sample receiving area is formed with substantially vapor-impermeable materials.

3. The sampling system of claim 2, wherein the porous metallic membrane of the sampling head is comprised of stainless steel.

4. The sampling system of claim 3, wherein the porous metallic membrane comprises a non-woven structure.

5. The sampling system of claim 1, wherein the surface of the transfer tube interior is coated with an inert material.

6. The sampling system of claim 5, wherein the transfer tube comprises a stainless steel tube.

7. The sampling system of claim 6, further comprising a heating element configured to resistively heat the stainless steel tube to a temperature between 120 and 250 degrees Celsius.

8. The sampling system of claim 1, wherein the sampling head further comprises at least one heating element disposed adjacent the porous metallic membrane, the at least one heating element being configured to heat the porous metallic membrane to a temperature that is between 140 and 250 degrees Celsius.

9. The sampling system of claim 1, wherein the sampling head and the transfer tube can be heated independently of one another to temperatures between 140 and 250 degrees Celsius.

10. The sampling system of claim 1, further comprising an analytical instrument coupled to the outlet end of the transfer tube.

11. The sampling system of claim 10, wherein the analytical instrument is a mass spectrometer.

12. A sampling head for volatilizing a sample from a test surface, the sampling head comprising:
a distal end comprising a porous metallic membrane configured to be brought into contact with the test surface;
a membrane support member having a first side that faces the porous metallic membrane, the first side having a recessed portion that is configured to direct the volatilized sample towards an opening in the first side;
a connector extending from a second side of the membrane support member and in fluid connection with the opening in the first side, the second side being opposite the first side and the connector being configured to be coupled to an inlet end of a transfer tube; and
a volatilized sample receiving area provided in the sampling head between the distal end of the sampling head and the first side of the membrane support member,
wherein all exposed surfaces in the volatilized sample receiving area consist essentially of vapor-impermeable materials.

13. The sampling head of claim 12, wherein the porous metallic membrane of the sampling head comprises stainless steel.

14. The sampling head of claim 13, wherein the porous metallic membrane comprises a non-woven structure.

15. The sampling head of claim 12, further comprises at least one heating element disposed adjacent the porous metallic membrane, the at least one heating element be configured to heat the porous metallic membrane to a temperature that is between 140 and 250 degrees Celsius.

16. The sampling head of claim 15, wherein the at least one heating element comprises a pair of cartridge heaters disposed on the second side of the membrane support member.

17. A method of collecting a volatilized sample from a test surface, the method comprising:
heating a distal end of a sampling head to a temperature of between 140 and 250 degrees Celsius, the distal end of the sampling head comprising a porous metallic membrane;
positioning the porous metallic membrane of the sampling head in contact with the test surface;
volatilizing a sample from the test surface and directing the volatilized sample into a volatilized sample receiving area, the volatilized sample receiving area being a volume of area in the sampling head between the distal end of the sampling head and an opening in the sampling head; and
directing the volatilized sample out of the sampling head through the opening in the sampling head,
wherein each of the exposed surfaces in the volatilized sample receiving area consists essentially of vapor-impermeable materials.

18. The method of claim 17, wherein the porous metallic membrane comprises a stainless steel membrane and the act of directing the volatilized sample into the volatilized sample receiving area comprises directing the volatilized sample through the stainless steel membrane.

19. The method of claim 17, further comprising:
directing the volatilized sample into an inlet end of a transfer tube, the opening in the sampling head being in fluid communication with the inlet end of the transfer tube;
directing the volatilized sample through the interior of the transfer tube to an outlet end of the transfer tube; and
directing the volatilized sample out of the outlet end of the transfer tube to a mass spectrometer.

20. The method of claim 18, wherein the act of directing the volatilized sample through the interior of the transfer tube comprises directing the volatilized sample through a stainless steel tube that is coated with an inert material.
